(19) United States
(12) Patent Application Publication
(10) Pub. No.: US 2023/0245188 A1
(43) Pub. Date: Aug. 3, 2023

(54) INFORMATION PROCESSING DEVICE, CONTROL METHOD, AND STORAGE MEDIUM

(71) Applicant: NEC Corporation, Minato-ku, Tokyo (JP)

(72) Inventors: Naoto Ohsaka, Tokyo (JP); Tatsuya Matsuoka, Minato-ku, Tokyo (JP)

(21) Appl. No.: 18/024,952

(22) PCT Filed: Sep. 7, 2020
(86) PCT No.: PCT/JP2020/033749

§ 371 Date: Mar. 6, 2023

(51) Int. Cl. G06Q 30/0601; G06Q 10/083

(52) U.S. Cl. CPC G06Q 30/0609; G06Q 30/0613; G06Q 10/083

(57) ABSTRACT

The information processing device 1X includes a seller information acquisition means 15Xa, a buyer information acquisition means 15Xb, a first determination means 15Xc, and a second determination means 16X. The seller information acquisition means 15Xa acquires seller information indicating sell conditions specified by each seller of a transaction target. The buyer information acquisition means 15Xb acquires buyer information indicating buy conditions specified by each buyer of the transaction target. The first determination means 15Xc determines a first combination of each seller and each buyer establishing transactions of the transaction target, based on the seller information, the buyer information, and a profit of a mediator mediating the transactions. When a change in conditions of the transaction occurs, the second determination means 16X determines a second combination of each seller and each buyer establishing the transactions, based on the change-reflected buyer information and seller information, the profit, and the first combination.

### TECHNICAL FIELD

The present disclosure relates to a technical field of an information processing device, a control method, and a storage medium for performing processing related to transactions.

### BACKGROUND ART

There are known systems to support matching of sellers and buyer of goods. For example, Patent Literature 1 discloses an electronic transaction mediation system configured to generate a plurality of candidates of the combination of the trader and the customer to meet desired transaction conditions of both the trader and the customer at the same time.

### CITATION LIST

### Patent Literature

Patent Literature 1: WO2002/027575

### SUMMARY

### Problem to be Solved

A mediator (dealers) such as a commercial company that mediates transactions formulates a plan by combining (matching) sellers of target goods of the transactions with buyers to meet the transaction conditions, such as the trading volume and the price, desired by the sellers and the buyers. In general, transaction conditions change on a daily basis depending on the convenience of sellers and buyers, and the sellers and the buyers strategically negotiate to change the transaction conditions. On the other hand, in such a case that there is a change in the transaction conditions, formulating a new plan that is greatly different from the initial plan could greatly affect the mediator due to the change.

In view of the issues described above, one object of the present invention is to provide an information processing device, a control method, and a storage medium capable of suitably determining a candidate for the combination of sellers and buyers of a transaction target.

### Means for Solving the Problem

In one mode of the information processing device, there is provided an information processing device including:

a seller information acquisition means configured to acquire seller information which indicates sell conditions specified by each of sellers of a transaction target;

a buyer information acquisition means configured to acquire buyer information which indicates buy conditions specified by each of buyers of the transaction target;

a first determination means configured to determine a first combination of each of the sellers and each of the buyers establishing transactions of the transaction target, based on the seller information, the buyer information, and a profit of a mediator which mediates the transactions; and

a second determination means configured, when a change in conditions of the transaction occurs, to determine a second combination of each of the sellers and each of the buyers establishing the transactions, based on the buyer information and the seller information in which the change is reflected, the profit of the mediator, and the first combination.

In one mode of the control method, there is provided a control method executed by a computer, the control method including:

acquiring seller information which indicates sell conditions specified by each of sellers of a transaction target;

acquiring buyer information which indicates buy conditions specified by each of buyers of the transaction target;

determining a first combination of each of the sellers and each of the buyers establishing transactions of the transaction target, based on the seller information, the buyer information, and a profit of a mediator which mediates the transactions; and

when a change in conditions of the transaction occurs, determining a second combination of each of the sellers and each of the buyers establishing the transactions, based on the buyer information and the seller information in which the change is reflected, the profit of the mediator, and the first combination.

In one mode of the storage medium, there is provided a storage medium storing a program executed by a computer, the program causing the computer to:

acquire seller information which indicates sell conditions specified by each of sellers of a transaction target;

acquire buyer information which indicates buy conditions specified by each of buyers of the transaction target;

determine a first combination of each of the sellers and each of the buyers establishing transactions of the transaction target, based on the seller information, the buyer information, and a profit of a mediator which mediates the transactions; and

when a change in conditions of the transaction occurs, determine a second combination of each of the sellers and each of the buyers establishing the transactions, based on the buyer information and the seller information in which the change is reflected, the profit of the mediator, and the first combination.

### Effect

An example advantage according to the present invention is to suitably determine candidates for the combination of sellers and buyers of a transaction target.

### BRIEF DESCRIPTION OF THE DRAWINGS

FIG. 1 illustrates the configuration of an optimization system in a first example embodiment.

FIG. 2 illustrates the hardware configuration of the information processing device.

FIG. 3 illustrates an example of the data structure of seller information.

FIG. 4 illustrates an example of the data structure of buyer information.

FIG. 5 illustrates an example of the data structure of vessel information.

FIG. 6 illustrates an example of the data structure of port information.

FIG. 7 illustrates an example of the data structure of plan information.

FIG. 8 illustrates an example of the functional block of the information processing device.

FIG. 9 illustrates a simplified specific example of the optimization process by the first determination unit.

FIG. 10 illustrates a simplified specific example of the optimization process by the second determination unit.

FIG. 11 illustrates a combination of the sellers and the buyers obtained through the optimization process on the assumption that the first determination unit performs the optimization process when the transaction conditions are changed.

FIG. 12 illustrates a display example of the matching detail screen image.

FIG. 13 illustrates a display example of the matching instruction screen image.

FIG. 14 illustrates an example of a flowchart showing a processing procedure performed by the information processing device according to the first example embodiment.

FIG. 15 illustrates a configuration of the optimization system in a second example embodiment.

FIG. 16 is a functional block diagram of the information processing device in a third example embodiment.

FIG. 17 is an example of a flowchart showing a processing procedure of the information processing device in the third example embodiment.

### EXAMPLE EMBODIMENTS

Hereinafter, example embodiments of an information processing device, a control method, and a storage medium will be described with reference to the drawings.

### First Example Embodiment

(1) System Configuration

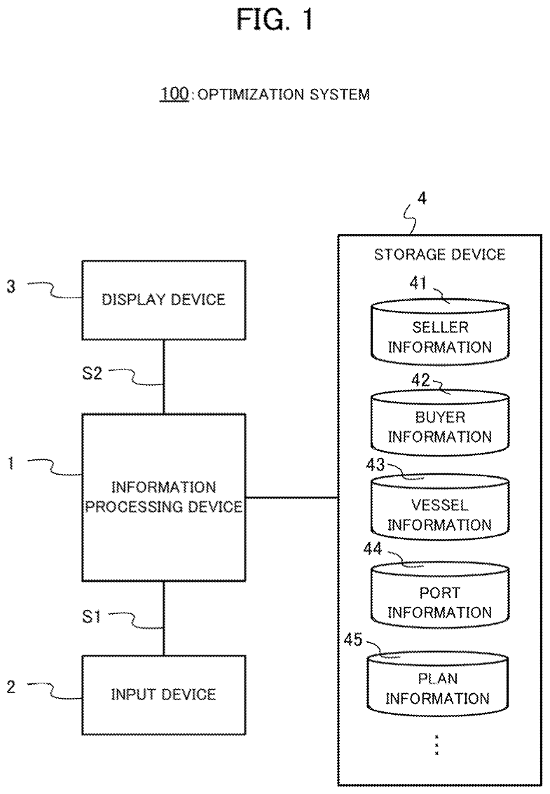

FIG. 1 shows a configuration of an optimization system 100 according to the first example embodiment. The optimization system 100 mainly includes an information processing device 1, an input device 2, a display device 3, and a storage device 4.

The information processing device 1 performs a process (simply referred to as “optimization process”) for determining the combination of the sellers and the buyers of goods (commodity) to be traded and optimizing the transport schedule of the goods. The information processing device 1 is preferably used by a trading company (firm) who mediates the purchase and sale of goods (transaction target) to be traded. Examples of the goods to be traded may include fuel such as LNG, steel, machinery, electronics, textiles, chemical products, medical-related goods, and foodstuffs. In the case that the goods to be traded are goods (e.g., LNG that evaporates over time) which cause the loss over time, it is necessary to smoothly transport goods from the seller to the buyer, and the need for optimization of the transport schedule becomes particularly high.

The information processing device 1 performs data communication with the input device 2, the display device 3, and the storage device 4 through a communication network or through direct wireless or wired communication.

The input device 2 is an interface that accepts the input by the user, and examples of the input device 2 include a touch panel, a button, a voice input device. The input device 2 supplies the input information “S1” generated based on the input from the user to the information processing device 1. In this case, for example, the information processing device 1 generates various kinds of information to be stored in the storage device 4 based on the input information S1 supplied from the input device 2, and specifies conditions or the like designated by the user with respect to the optimization process.

The display device 3 displays information based on the display information “S2” supplied from the information processing device 1, and examples of the display device 3 include a display and a projector.

The storage device 4 is a memory for storing various kinds of information necessary for the optimization process. The storage device 4 may be an external storage device such as a hard disk connected to or built in to the information processing device 1, or may be a storage medium such as a flash memory. The storage device 4 may be a server device that performs data communication with the information processing device 1. In this case, the storage device 4 may be configured by a plurality of server devices.

The storage device 4 stores seller information 41, buyer information 42, vessel information 43, port information 44, and plan information 45. The seller information 41 is information relating to the sellers of the goods to be traded via the user of the information processing device 1. The buyer information 42 is information relating to the buyers of goods to be traded via the user of the information processing device 1. The vessel information 43 is information relating to vessels which can be used, to transport the goods to be traded, by the mediator (e.g., trading company) that is the user of the information processing device 1. The port information 44 refers to information on ports (ports of loading or ports of discharge) to be used for transporting goods subject to transaction. The plan information 45 is information indicating a plan determined through an optimization process using temporarily-determined transaction conditions, and includes information indicating the transaction conditions used for the optimization process and the result of the optimization process. The transaction conditions herein indicate conditions necessary for matching (determination of the combination of the sellers and the buyers, and the transport schedule), and are determined by the seller information 41, the buyer information 42, the vessel information 43, and the port information 44.

In addition to the information described above, the storage device 4 may store various kinds of information necessary for the optimization process. For example, the storage device 4 may further store information necessary for calculating the price of the goods to be traded, and the like. Further, the seller information 41, the buyer information 42, the vessel information 43, the port information 44, and the plan information 45 may be generated by a device other than the information processing device 1 in advance, or may be information which the information processing device 1 generates and/or updates based on the input information outputted from the input device 2.

In some embodiments, the storage device 4 may store information regarding the loss with respect to the goods that deteriorate over time. In this case, for example, the information regarding the loss may be information on the amount of loss per unit time that is caused by the deterioration of the goods to be traded over time, or may be information indicating the ratio of decrease in the amount of the goods per unit time.

The configuration of the optimization system 100 shown in FIG. 1 is an example, various changes may be applied to the above configuration. For example, the input device 2 and the display device 3 may be integrated into one device. In this case, the input device 2 and the display device 3 may be configured as a tablet terminal integral with or separate from the information processing device 1. Further, the information processing device 1 may be configured by a plurality of devices. In this case, the plurality of devices functioning the information processing device 1 perform the transmission and reception of information necessary for executing the pre-allocated processing among these devices.

(2) Hardware Configuration of Information Processing Device

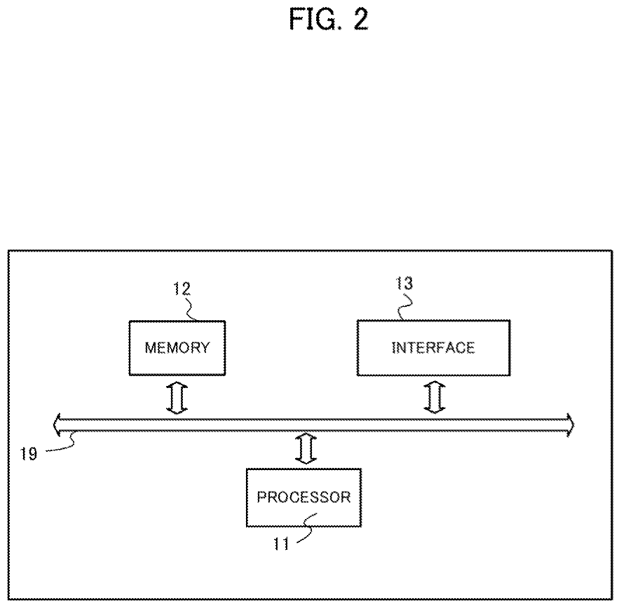

FIG. 2 shows the hardware configuration of the information processing device 1. The information processing device 1 includes a processor 11, a memory 12, and an interface 13 as hardware. The processor 11, the memory 12, and the interface 13 are connected to one another via a data bus 19.

The processor 11 executes a predetermined process by executing a program stored in the memory 12. The processor 11 is one or more processors such as a CPU (Central Processing Unit) and a GPU (Graphics Processing Unit).

The memory 12 is configured by various volatile memories and non-volatile memories such as a RAM (Random Access Memory) and a ROM (Read Only Memory). In addition, a program for executing an optimization process executed by the information processing device 1 is stored in the memory 12. The memory 12 is used as a work memory and temporarily stores information acquired from the storage device 4. The memory 12 may function as a storage device 4. Similarly, the storage device 4 may function as a memory 12 of the information processing device 1. The program executed by the information processing device 1 may be stored in a storage medium other than the memory 12.

The interface 13 is an interface for electrically connecting the information processing device 1 and other devices. For example, the interface 13 includes an interface for connecting the information processing device 1 and the input device 2, an interface for connecting the information processing device 1 and the display device 3, and an interface for connecting the information processing device 1 and the storage device 4. For example, the interface for connecting the information processing device 1 and the storage device 4 is a communication interface such as a network adapter for wired or wireless transmission and reception of data to and from the storage device 4 under the control of the processor 11. In another example, the information processing device 1 and the storage device 4 may be connected by a cable or the like. In this case, the interface 13 includes an interface which conforms to USB (Universal Serial Bus), SATA (Serial AT Attachment) or the like for exchanging data with the storage device 4.

The hardware configuration of the information processing device 1 is not limited to the configuration shown in FIG. 2. For example, the information processing device 1 may include at least one of an input device 2 or a display device 3. Further, the information processing device 1 may be connected to or incorporate a sound output device such as a speaker.

(3) Data Structure

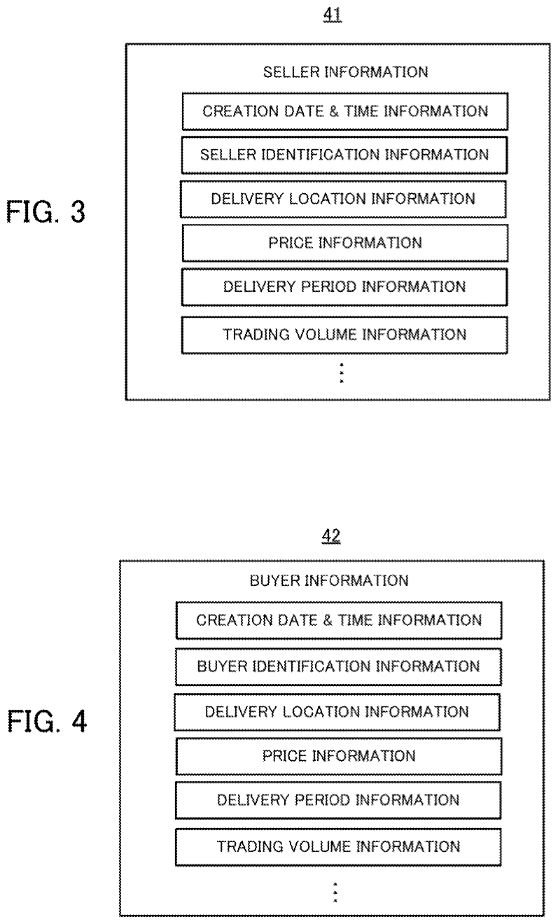

Next, an example of a data structure of various kinds of information stored in the storage device 4 will be described with reference to FIGS. 3 to 7.

FIG. 3 is an example of the data structure of seller information 41. The seller information 41 is information generated with respect to each of the sellers of goods to be traded, and is information indicating the sell conditions (i.e., the terms of transaction desired by each seller) presented by each seller. Specifically, seller information 41 includes creation date and time information, seller identification information, delivery location information, price information, delivery period information, loading port information, and trading volume information. Incidentally, the seller information 41 may be information indicating a table or a list having a record with respect to each seller.

The “creation date and time information” is information indicating the date and time when the seller information 41 of interest is generated or changed. Plural records of the seller information 41 whose creation date and time information is different from each other for the same seller may be stored in the storage device 4. The “seller identification information” is information that identifies each seller of goods to be traded. The seller identification information may include information on the attributes of each seller, such as the company name and location of each seller, in addition to the peculiar ID (seller ID) identifying each seller.

The “delivery location information” is information on the delivery location of the transaction target desired by each seller. For example, the delivery location information includes information indicating whether the delivery location is a port of loading or a port of discharge, and information regarding the port to be the delivery location.

The “price information” is information that indicates the price of goods to be traded desired by each seller. The “delivery period information” is information indicating the delivery period of the goods to be traded desired by each seller. The delivery period is generally set to a longer period as the schedule to delivery is ahead, and is determined in detail as it approaches the timing of delivery.

The “trading volume information” is information indicating the trading volume of goods desired by each seller. For example, the trading volume information is information indicating the lower limit and the upper limit of the trading volume of the goods desired by each seller, respectively. It is noted that when the goods to be traded is fuel, the trading volume is the amount of heat.

FIG. 4 is an example of the data structure of the buyer information 42. The buyer information 42 is information generated for each of the buyers of goods to be traded and indicates the buy conditions (i.e., the terms of purchase desired by each buyer) presented by each buyer.

Specifically, the buyer information 42 includes creation date and time information, buyer identification information, delivery location information, price information, delivery period information, discharging port information, and trading volume information. The buyer information 42 may be information indicating a table or a list having a record with respect to each buyer.

The “creation date and time information” is information indicating the date and time when the buyer information 42 of interest is generated or changed. Plural records of the buyer information 42 whose creation date and time information is different from each other for the same seller may be stored in the storage device 4. The “buyer identification information” is information that identifies each buyer of goods to be traded. The buyer identification information may include information on the attributes of each buyer, such as the company name and location of each buyer, in addition to the peculiar ID (buyer ID) identifying each buyer.

The “delivery location information” is information on the location of delivery of the transaction target desired by each buyer. For example, the delivery location information includes information indicating whether the delivery location is a port of loading or a port of discharge, and information regarding the port to be the delivery location.

The “price information” is information that indicates the price of goods to be traded desired by each buyer. The “delivery period information” is information indicating the delivery period of goods to be traded desired by each buyer. The delivery period is generally set to a longer period as the schedule to delivery is ahead, and is determined in detail as it approaches the timing of delivery.

The “trading volume information” is information that indicates the volume of traded goods desired by the target buyer. For example, the volume information is information indicating the lower limit and the upper limit of the trading volume of goods desired by the target buyer, respectively.

The information processing device 1 changes the transaction conditions indicated by each of the seller information 41 and the buyer information 42 based on the input information S1 supplied from the input device 2. For example, the information processing device 1 displays an optimized combination of the sellers and the buyers on the display device 3 together with the transaction conditions desired by the seller and the transaction conditions desired by the buyer, and receives the change in these transaction conditions by detecting input operation to the input device 2. When the information processing device 1 receives the input information S1 instructing the change in the transaction conditions from the input device 2, the information processing device 1 changes the corresponding seller information 41 or the buyer information 42 based on the input information S1. In this case, the information processing device 1 may store the seller information 41 and the buyer information 42 before the change and the seller information 41 and the buyer information 42 after the change as the seller information 41 and the buyer information 42 having different “creation date and time information” described above in the storage device 4, respectively.

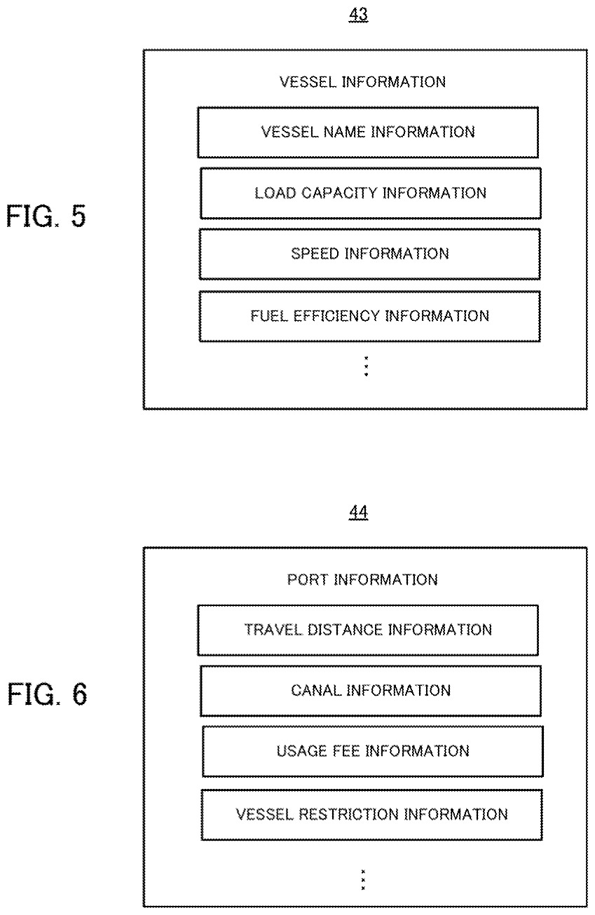

FIG. 5 is an example of the data structure of the vessel information 43. The vessel information 43 is information generated for each of the vessels that the user of the information processing device 1 can use, and mainly includes vessel name information, load capacity (burden) information, speed information, and fuel efficiency information. The vessel information 43 may be information indicating a table or a list having a record with respect to each vessel. Examples of transport information include the vessel information 43 and the port information 44 to be described later.

The “vessel name information” is information indicating the name of each vessel. The “load capacity information” is information that indicates the amount of goods that each vessel can load. The “speed information” is information on the speed of each vessel (e.g., maximum speed and average speed). The “fuel efficiency information” is information on the fuel efficiency of each vessel. In some embodiments, the fuel efficiency information is information indicating the fuel efficiency of each vessel in accordance with the speed.

It is noted that the vessel information 43 may be information on vessels (chartered vessels) which can be borrowed in a short term by the user of the information processing device 1. In this case, the vessel information 43 may further include information on the cost of the chartered vessel (such as the chartered cost per day, the fixed cost of the chartered vessel). The vessel information 43 may also further include information on the category of each vessel, information on the size of each vessel, and the like.

FIG. 6 is an example of the data structure of the port information 44. The port information 44 is information regarding a port that is a candidate for a port of loading or a port of discharge, including travel distance information, canal information, usage fee information, and vessel restriction information.

The “travel distance information” is information indicating the travel distance between ports. The travel distance information is, for example, a table information indicating the travel distance from a port of loading to a port of discharge with respect to each possible combination of a candidate port of loading and a candidate port of discharge.

The “canal information” is information that indicates the canals (e.g., Panama Canal and Suez Canal) where a toll to pass when traveling between ports occurs. The canal information is, for example, a table information indicating the canal to pass when moving from a port of loading to a port of discharge with respect to each possible combination of a candidate port of loading and a candidate port of discharge.

The “usage fee information” is information indicating a usage fee for each port. The usage fee information may also include information on the toll of the canal where the toll occurs.

The “vessel restriction information” is information indicating vessels that are not permitted to use each port. For example, the vessel restriction information is a table information indicating, for each port, the presence or absence of restrictions for each of the vessels that the user of the information processing device 1 can use.

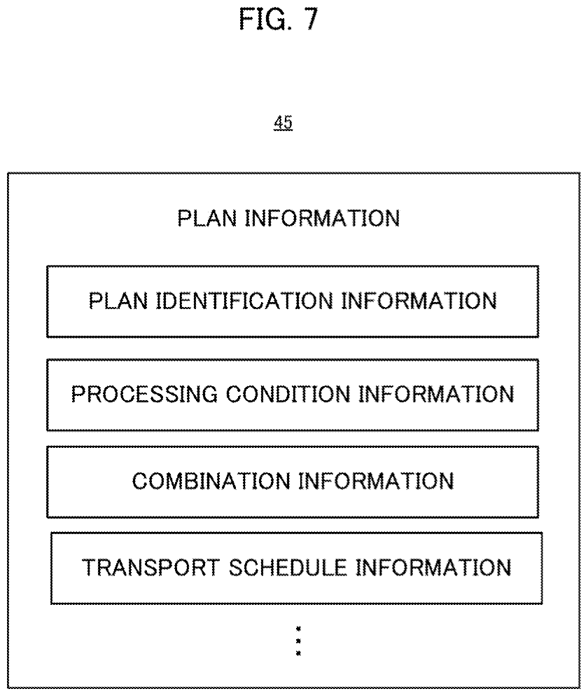

FIG. 7 is an example of the data structure of the plan information 45. The plan information 45 is information generated for each plan related to the entire transactions, and includes plan identification information, processing condition information, combination information, and transport schedule information.

The “plan identification information” is identification information allocated for each plan. For example, the plan identification information is information that indicates the name (plan name) of the plan specified by user input or the like. The “processing condition information” is information indicating the conditions used when the optimization process regarding the plan is executed. For example, the processing condition information is information for identifying the seller information 41 and the buyer information 42 used in the optimization process regarding the plan. In this case, for example, the processing condition information includes the creation date and time information and the seller identification information of the seller information 41 and the creation date and time information and the buyer identification information of the buyer information 42 which were used for the optimization process regarding the plan. In another example, the processing condition information may include information indicating the sell conditions and the buy conditions which were used for the optimization process of the plan.

The “combination information” is information indicating the combination of the sellers and the buyers matched in the optimization process regarding the plan. The “transport schedule information” is information indicating the transport schedule determined in the optimization process regarding the plan. In addition to the above-mentioned information, the plan information 45 may further include information such as the profit, revenue, and cost (expense) of the mediator that occurs when the combination of the sellers and the buyers indicated by the corresponding combination information and the transport schedule indicated by the corresponding transport schedule information are adopted. In another example, the plan information 45 may include information of the optimal transaction conditions (e.g., trading volume and delivery time) in each combined transaction.

The plan information 45 may be information indicating a plan before the optimization process is executed. The plan information 45 in this case does not initially include the “combination information” and the “transport schedule information”, and the “combination information” and the “transport schedule information” are added to the plan information after the execution of the optimization process.

(4) Details of Optimization Process

Next, a description will be given of the optimization process in the first example embodiment. In summary, when the optimization process is performed by changing the transaction conditions after the determination of the combination of the sellers and the buyers establishing the transactions and the transport schedule, the information processing device 1 re-determines the combination of the sellers and the buyers and the transport schedule in consideration of the degree of consistency (similarity) with the result before the change of the transaction conditions. Thereby, the information processing device 1 suitably determines the combination of the sellers and the buyers and the transport schedule satisfying the changed transaction conditions while minimizing the influence caused by the change of the plan.

Hereafter, for convenience of explanation, the plan corresponding to the combination of the sellers and the buyers and the transport schedule determined before the change of the transaction conditions is referred to as “initial plan”, and the plan corresponding to the combination of the sellers and the buyers and the transport schedule determined after the change of the transaction conditions is referred to as “change reflection plan”.

(4-1) Functional Block

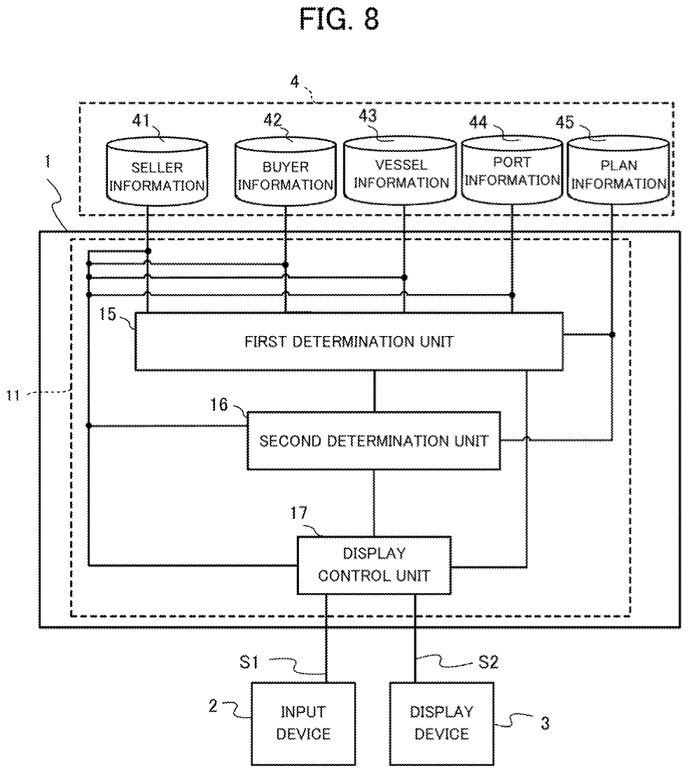

FIG. 8 is an example of a functional block of the information processing device 1 that executes an optimization process related to the determination of the combination of the sellers and the buyers and the vessel transport schedule. The processor 11 of the information processing device 1 functionally includes a first determination unit 15, a second determination unit 16, and a display control unit 17. In FIG. 8, any blocks to exchange data with each other are connected by solid line, but the combination of blocks to exchange data is not limited to FIG. 8. The same is true for the drawings of other functional blocks described below.

The first determination unit 15 determines the combination of the sellers and the buyers and the transport schedule which establish the transactions by performing the optimization which maximizes the profit of the mediator. In this case, the first determination unit 15 acquires the seller information 41 corresponding to a plurality of sellers to be matched by referring to the storage device 4. The first determination unit 15 acquires buyer information 42 corresponding to a plurality of buyers to be matched by referring to the storage device 4. In addition, the first determination unit 15 acquires the vessel information 43 and the port information 44 that are the transport information on the goods to be traded, by referring to the storage device 4. Then, the first determination unit 15 sets constraints based on the seller information 41, the buyer information 42, and the transport information, and determines the combination of the sellers and the buyers and the transport schedule that maximizes the profit of the mediator by optimization. The optimization to be performed by the first determination unit 15 will be described in detail in the section “(4-2) Optimization in First Determination Unit”. The combination of the sellers and the buyers determined by the first determination unit 15 is an example of “the first combination”.

The first determination unit 15 stores the information representing the execution result of the optimization process as the plan information 45 in the storage device 4. In this case, as illustrated in the data structure in FIG. 7, the first determination unit 15 stores the plan information 45 in which the plan identification information indicating the plan of interest is associated with the processing condition information, the combination information, the transport schedule information, and the like. The information that the first determination unit 15 stores in the storage device 4 as the plan information 45 is referred to by the second determination unit 16 as information indicating the initial plan.

When the second determination unit 16 receives the information instructing re-execution of the optimization process by changing the transaction conditions from the display control unit 17, the second determination unit 16 refers to the plan information 45 indicating the combination of the sellers and the buyers and the transport schedule according to the initial plan and re-determines the combination of the sellers and the buyers and the transport schedule. In this case, the second determination unit 16 determines the combination of the sellers and the buyers and the transport schedule so as to maximize: the degree of coincidence (also referred to as “coincidence degree g”) with the combination of the sellers and the buyers and the transport schedule according to the initial plan; and the objective function (evaluation function) based on the profit of the mediator. The optimization performed by the second determination unit 16 will be described in detail in the section “(4-3) Optimization in Second Determination unit”. The second determination unit 16 stores information representing the execution result of the optimization process in the storage device 4 as the plan information 45. The changed part of the transaction conditions may be the sell conditions indicated by the seller information 41 or the buy conditions indicated by the buyer information 42, or may be a change in the usable period of a particular vessel due to a transport delay or the like. The combination of the sellers and the buyers determined by the second determination unit 16 is an example of “the second combination”.

The display control unit 17 generates the display information S2 for displaying a screen image (also referred to as “matching screen image”) indicating the combination of the sellers and the buyers determined by the first determination unit 15 or the second determination unit 16. Then, by supplying the generated display information S2 to the display device 3, the display control unit 17 displays a matching screen image on the display device 3. The display control unit 17 receives the input instructing the change in the transaction conditions on the matching screen image and supplies the information on the changed transaction conditions to the storage device 4 or the second determination unit 16. Furthermore, the display control unit 17 receives the input, on the matching screen image, for specifying the parameters required in the optimization process to be executed by the second determination unit 16, and supplies input information S1 indicating the received parameters to the second determination unit 16. The display example of the matching screen image will be described later.

Each component of the first determination unit 15, the second determination unit 16 and the display control unit 17 described in FIG. 8 can be realized, for example, by the processor 11 executing a program. The necessary programs may be recorded on any non-volatile storage medium and installed as necessary to realize each component. It should be noted that at least a portion of these components may be implemented by any combination of hardware, firmware, and software, or the like, without being limited to being implemented by software based on a program. At least some of these components may also be implemented using a user programmable integrated circuit such as a FPGA (Field-Programmable Gate Array) and a microcontroller. In this case, the integrated circuit may be used to realize a program to function as each of the above components. Further, at least some of the components may be realized by a ASSP (Application Specific Standard Produce), a ASIC (Application Specific Integrated Circuit), or a quantum processor (quantum computer control chip). Thus, each component may be implemented by various hardware. The above is also true for other example embodiments described later. Furthermore, each of these components may be implemented by the cooperation of a plurality of computers, for example, using cloud computing technology.

(4-2) Optimization in First Determination Unit

On the basis of the seller information 41, the buyer information 42, and the transport information, the first determination unit 15 performs combinational optimization that maximizes the profit of the user of the information processing device 1 while using the transaction conditions regarding the transaction target as constraints. In other words, the first determination unit 15 performs the optimization of the combination of the sellers and the buyers and the transport schedule which establish the transactions so as to maximize the profit of the user of the information processing device 1 while satisfying the constraints relating to the sales of the transaction target.

In this case, for example, the first determination unit 15 considers a combinatorial optimization problem to determine the combination of the sellers and the buyers and the transport schedule which maximize the profit of a mediator who is a user of the information processing device 1 and formulates it into an integer programming (mixed integer programming) problem. In other words, the first determination unit 15 considers the combination of the sellers, the buyers, the vessels to be used, and the navigation period of the vessels as a combination optimization problem and formulates it into an integer programming problem. The first determination unit 15 obtains a solution on the formulated integer programming problem by performing a process equivalent to the process by a general application program (e.g., IBM ILOG CPLEX, Gurobi Optimizer, SCIP). Specifically, the first determination unit 15 inputs, to the above-described application program, constraints on the transactions and the transport in the form of linear integer constraints and a linear objective function that defines the profit. Thereby, the first determination unit 15 recognizes the transactions and the transport plan that maximizes the profit. In this case, the first determination unit 15 also determines the delivery time and the trading volume and the like, at which the profit of the user is maximized. It is noted the assignment of vessels when transport is required can also be described as integer constraints.

In the above-described integer programming problem, the first determination unit 15 sets the objective function representing the gross profit of the mediator and the linear integer constraints on the transactions and the transport based on the information on the price of the goods to be traded and the transportation date (the date of delivery).

Here, a description will be given of the conditions for the transactions and the transport, which are defined as linear integer constraints.

For example, the first determination unit 15 determines a constraint for transactions to be a condition that the delivery period indicated by the delivery period information included in the seller information 41 is matched (consistent) with the delivery period indicated by the buyer information 42. In this case, if the goods to be traded are required to be transported, the first determination unit 15 calculates the approximate number of navigation days taken to navigate from the port of loading designated by the seller to the port of discharge designated by the buyer, based on the vessel information 43 and the port information 44. The first determination unit 15 determines whether or not it is possible to perform the delivery from the seller to the mediator (i.e., the user of the information processing device 1) during the delivery period designated by the seller and the delivery from the mediator to the buyer during the delivery period designated by the buyer, taking into consideration the calculated number of navigation days.

The number of navigation days indicating the length of the navigation period is the number of days required to move the vessel to the port of loading and the number of days required to transport the goods to be traded. Here, the first determination unit 15 calculates the above-described number of days required for each vessel to undertake transactions based on, for example, the loading port information included in the seller information 41 and the discharging port information included in the buyer information 42, the travel distance information included in the port information 44, and the speed information included in the vessel information 43.

For example, the appropriate difference in the delivery period required for establishing the matching depending on the travel distance can be described in the form of linear integer constraints as follows.

Now, by use of integers S and B, it is assumed that there are S sellers and B buyers, and that the seller's index is “s=1, 2, . . . , S” and the buyer's index is “b=1, 2, . . . , B.” It is also assumed that x_{s, b} is a variable with a value of either 0 or 1, and x_{s, b}=1 means to sell what is sourced from the seller s to the buyer b. In this case, the one-to-one correspondence between the seller and the buyer can be expressed as follows.

$$\begin{matrix}[ Formula 1 ] & \\ For each s = 1 , 2 , … , S , & \end{matrix}$$

$${\sum }_{{b}^{′} = 1}^{B} {x}_{s , {b}^{′}} = 1$$

$$\begin{matrix}[ Formula 2 ] & \\ For each b = 1 , 2 , … , B , & \end{matrix}$$

$${\sum }_{{s}^{′} = 1}^{S} {x}_{{s}^{′} , b} = 1$$

Here, the purchase time from the seller s is expressed by the variable “tₛ”, and similarly, the delivery time to the buyer b is expressed by the variable “t_{b}”. In addition, the duration of transport from the seller s to the buyer b is indicated by “d_{s, b}”. At this time, by using a sufficiently large positive constant “M”, the constraint that the transportation time is guaranteed can be expressed as follows.

[Formula 3]

With respect to each s=1, 2, . . . , S and each b=1, 2, . . . , B,

t_{b}−tₛ≥d_{s,b}x_{s,b}−M(1−x_{s,b})

This formula is explained as follows. If it is not transported from the sellers to the buyer b, the equation “x_{s, b}=0” is satisfied. At this time, since M is sufficiently large, the following inequality is always true and thus the constraint is deactivated.

t_{b}−tₛ≥−M

On the other hand, the equation “x_{s, b}=1” is satisfied when it is transported from the seller s to the buyer b. At this time, the following constraint is required and this inequality means that a sufficient transit time is ensured.

t_{b}−tₛ≥d_{s,b}

Also, the constraint on the purchase (receipt) time tₛ from the seller can be expressed as follows.

T_{s,1}≤tₛ≤T_{s,2}

This means that the receiving time must be between the time “T_{s, 1}” and the time “T_{s, 2}”.

In addition, the first determination unit 15 assigns a vessel to be used for each transaction and determines the navigation period so that the delivery of goods from the seller during the delivery period indicated by the delivery period information included in the seller information 41 and the delivery of goods to the buyer during the delivery period indicated by the delivery period information included in the buyer information 42 can be carried out. The assignment of vessels can be described in the form of linear integer constraints as follows.

Now, it is assumed that “v=1, 2, . . . , V” is the index of the vessel and the variable “y_{s, v}” is a variable that is either 0 or 1 for the seller “s=1, 2, . . . , S”. Also, “y_{s, v}=1” represents transactions with the seller s using the vessel v. At this time, the constraint of allocating one of the vessels to each transaction can be expressed as follows.

$$\begin{matrix}[ Formula 4 ] & \\ For each s = 1 , 2 , … , S , & \end{matrix}$$

$${\sum }_{{v}^{′} = 1}^{V} {y}_{s , {v}^{′}} = 1$$

In addition, for each transaction of each seller s, “C(s)⊆{1, 2, . . . , S}” shall represent a seller who cannot transport goods by the same vessel as the vessel used in the transactions for the seller s. This means that, if the vessel v is allocated to the transactions of the seller s, the vessel v cannot arrive in time to the trading time of the other seller “s∈C(s)” included in C(s). At this time, such a constraint that the assignment of vessels does not collide among the transactions of multiple sellers can be expressed as follows using a sufficiently large positive constant M.

$$\begin{matrix}[ Formula 5 ] & \\ With respect to each s = 1 , 2 , … , S and each v = 1 , 2 , … , V , & \end{matrix}$$

$${\sum }_{{s}^{′} ∈ C ( s )} {y}_{{s}^{′} , v} \leq M ( 1 - {y}_{s , v} )$$

This constraint is explained as follows. If y_{s, v}=0 is satisfied and the vessel v is not assigned to the transactions of the seller s, the constraint is invalid because M is large enough. On the other hand, if y_{s, v}=1 is satisfied and the vessel v is assigned to the transactions of the seller s, then “y_{s′, v}=0” must be satisfied for the transactions of the seller s′ contained in C(s), which means that the vessel v is not assigned to the transactions of the other seller “s′∈C(s)”.

The actual implementation method is not limited to the above example. For example, while the above example deals with a case where the travel time is fixed and known in advance, constraints in the case where the speed of the vessel can be adjusted can be expressed in the same manner. Although the description was given of such an example that the collision of vessel assignments is expressed only by allocations to sellers, the constraints for cases where both sellers and buyers are affected by the collision of vessel assignments can also be described.

Further, for example, the first determination unit 15 makes it a constraint of the transactions that the range of the trading volume indicated by the trading volume information included in the seller information 41 overlaps with the range of the trading volume indicated by the trading volume information included in the buyer information 42.

Further, for example, the first determination unit 15 makes it a constraint of the transactions that the price (i.e., the desired sale value) desired by the seller and the price (i.e., the desired purchase value) desired by the buyer satisfies a predetermined relation. In this case, for example, the above-described relation may be expressed by an expression or an inequality that defines that the desired sale value is within a predetermined ratio of the desired purchase value. In this case, for example, the first determination unit 15 may determine the transaction price to be an intermediate value between the desired sale value and the desired purchase value, or may determine the transaction price based on a predetermined formula with the desired sale value and the desired purchase value determined in advance.

In addition to or in place of the above-described conditions, the first determination unit 15 may be set linear integer constraints for various conditions necessary for establishing the transactions of the trading target.

Next, a supplemental description will be given of the profit, which is set as an objective function in the above-mentioned integer programming problem, of the user of the information processing device 1 that is a mediator. For example, a predetermined percentage of the total amount of the transactions is generated as the profit of the mediator. In addition, in the case of transactions involving transport by the mediator, the amount corresponding to the fixed fee or the transport fee arises as the profit of the mediator. Therefore, when the combination of the sellers and the buyers is determined, it is possible to determine the predicted value of the user's profit based on the transaction price. Accordingly, the first determination unit 15 solves the above-described combinatorial optimization problem so that the predicted value of the profit of the mediator computed in this manner is maximized. The profit of the mediator can typically be formulated as the gross sales price minus the gross purchase price and transportation costs.

Further, the first determination unit 15 may determine the predicted value of the far-future profit (e.g., the predicted value of the profit at the time after a predetermined period or more) of the user by multiplying it by a decay rate that is less than 1.

For example, in the above-mentioned example, when the profit “p_{s, b}” of the delivery from the seller s to the buyer b and the cost “c_{s, v}” of the vessel v for the delivery from the seller s are given in advance, the gross profit (equal to the profit minus the cost regarding the transactions) can be expressed as the following expression (1).

$$\begin{matrix}[ Formula 6 ] & \\ {\sum }_{s = 1}^{S} {\sum }_{b = 1}^{B} {p}_{s , b} {x}_{s , b} - {\sum }_{s = 1}^{S} {\sum }_{v = 1}^{V} {c}_{s , v} {y}_{s , v} & ( 1 )\end{matrix}$$

By solving an integer programming problem, whose objective function is the above expression (1), based on linear constraints under the above constraints, a transportation schedule that maximizes the profit is calculated.

The above explanation is just an example, and the implementation is not limited thereto. For example, transport costs may include a variety of things, such as port usage costs and fuel costs, and may be rewritten in a manner that relies on buyers as well.

Further, the first determination unit 15 may determine the transport schedule to maximize the profit of the user of the information processing device 1 in further consideration of the delivery location information included in the seller information 41, the delivery location information included in the buyer information 42, the travel distance information included in the port information 44, and the fuel efficiency information for each speed included in the vessel information 43. Thus, for example, the first determination unit 15 determines a long navigation period so as to prioritize fuel efficiency over speed in such transactions that there is a relatively large margin in the schedule of the vessel (i.e., the number of navigation days can be longer). Thereby, it is possible to increase the profit of the user of the information processing device 1. On the other hand, the first determination unit 15 shortens the navigation period by giving priority to shortening the number of navigation days rather than the fuel efficiency in such transactions that there is relatively little margin in the schedule of the vessel (i.e., when transaction using the target vessel are consecutive, and the like).

In addition, when goods that causes a loss with time is to be traded, the first determination unit 15 acquires from the storage device 4 information on the amount of loss over the lapse of time regarding the goods in units of time, and determines a transportation schedule in further consideration of the information to maximize the profit of the user of the information processing device 1. Thereby, the first determination unit 15 can determine the transportation schedule so that the profit of the user of the information processing device 1 is maximized even when goods such as LNG which is supposed to be reduced due to evaporation are to be traded.

Here, a supplementary explanation will be given for the case where the number of buyers does not coincide with the number of sellers. In this case, for example, the first determination unit 15 may generate temporary seller information (also referred to as “temporary seller information”) or temporary buyer information (also referred to as “temporary buyer information”). Specifically, when the number of sellers is less than the number of buyers, the first determination unit 15 generates one or more pieces, according to the number of shortages of the sellers, of temporary seller information indicating typical (representative) transaction conditions (regarding price, delivery location, delivery period, trading volume, etc.,) to be offered by a seller. Similarly, when the number of buyers is less than the number of sellers, the first determination unit 15 generates one or more pieces, according to the number of shortages of the buyers, temporary buyer information indicating the typical (representative) transaction conditions (regarding price, delivery location, delivery period, trading volume, etc.,) to be offered by a buyer. It is noted that the delivery period indicated by the temporary seller information and the temporary buyer information may be set to be long enough to facilitate matching of the buyers and sellers. The temporary seller information and the temporary buyer information may be stored in advance in the storage device 4. In this case, for example, based on the matching result using the temporary seller information and the temporary buyer information, the user of the information processing device 1 can use the matching result as a guideline regarding whether or not to procure additional transaction partners.

(4-3) Optimization by Second Determination Unit

The second determination unit 16 sets an objective function based on (having a positive correlation with) the coincidence degree g indicating closeness to the initial plan and the profit of the mediator. Then, the second determination unit 16 determines the combination of the sellers and the buyers and the transport schedule so as to maximize the objective function while satisfying the constraints based on the transaction conditions after the change.

Here, assuming that “α” denotes the variable vector representing the matching result to be determined, “R” denotes the set of all allowable matchings (i.e., all matchings satisfying the transaction conditions) and “f” denotes the function (i.e., the function corresponding to the expression (1)) representing the gross profit of the mediator, the optimization problem to be solved by the first determination unit 15 is formulated as the following expression (2).

$$\begin{matrix}[ Formula 7 ] & \\ {max}_{α ∈ R} f ( α ) & ( 2 )\end{matrix}$$

On the other hand, a description will be given of the case where α is to be determined again while changing the transaction conditions. Assuming that “β” denotes a vector (fixed vector) representing the matching result of the initial plan, “g (α, β)” denotes a function representing the coincidence degree between α, and “λ” denotes the weight parameter of the coincidence degree g, the optimization problem to be solved by the second determination unit 16 is formulated as shown in the following expression (3).

$$\begin{matrix}[ Formula 8 ] & \\ {max}_{α ∈ R} f ( α ) + λ \cdot g ( α , β ) & ( 3 )\end{matrix}$$

According to the expression (3), the larger the parameter λ is, the more emphasis is placed on increasing the coincidence degree g (α, β) over the profit f (α).

Here, a specific example of the coincidence degree g will be described below. Hereafter, α is denoted as “α=(α₁, . . . αₙ)” and β is denoted as “β=(β₁, . . . , βₙ)”, and “i” (i=1, . . . , n) denotes possible combinations (sets) of the seller, the buyer, and the vessel to be used (i.e., “i=(s, b, v)” according to the notations in the expression (1)). Namely, n=S×B×V when there are S sellers, B buyers, and V vessels. In addition, “αᵢ” and “βᵢ” shall be set to “1” when a combination of the seller, the buyer, and the vessel with index i is adopted, and shall be set to “0” when the combination is not adopted.

In this case, for example, the second determination unit 16 calculates the coincidence degree “g (α, β)” as the number of indices i (i=1, . . . , n) that satisfy (αᵢ=βᵢ) as shown in the expression (4) below.

$$\begin{matrix}[ Formula 9 ] & \\ g ( α , β ) = {\sum }_{i = 1}^{n} [ 1 {if}^{‶} {α}_{i} = {β}_{i} = {1}^{″} ] & ( 4 )\end{matrix}$$

In other words, in this case the coincidence degree “g (α, β)” is defined as the number of sets of the seller, the buyer, and the vessel in common between the initial plan and the change reflection plan. Incidentally, the coincidence degree g does not need to be the above-mentioned number itself described above, and it may be a value having a positive correlation with the above-mentioned number of the sets. In this case, the second determination unit 16 may determine the coincidence degree g from the above-mentioned number of the sets with reference to a predetermined expression or a look-up table.

In some embodiments, the second determination unit 16 may perform weighting based on the degree of importance of each index i (i.e., a combination of the seller, the buyer, and the vessel) in calculating the coincidence degree “g (α, β)”. In this case, the weighted coincidence degree g is shown in the following expression (5), assuming that the weight for index i is “wᵢ”.

$$\begin{matrix}[ Formula 10 ] & \\ g ( α , β ) = {\sum }_{i = 1}^{n} {w}_{i} \cdot [ 1 {if}^{‶} {α}_{i} = {β}_{i} = {1}^{″} ] & ( 5 )\end{matrix}$$

A description will be given of the method of setting the weight wᵢ. In some embodiments, the second determination unit 16 determines the weight wᵢ based on at least one of the delivery period (i.e., time to carry the goods) of the goods to be traded or the profit derived from the set corresponding to the weight wᵢ.

A description will be given of the method of determining the weight wᵢ based on the delivery period of the goods to be traded. For example, the earlier the delivery period (i.e., time to carry the goods) of the combination (set) corresponding to the index i is, the larger weight wᵢ the second determination unit 16 assigns. The weighting is based on such general circumstances that the later the delivery time of the combination is, the easier it is to negotiate to change the contract thereof, and that the sooner the delivery time of the combination (set) is, the greater the impact to change the contract thereof is (i.e., the greater the difficulty caused by the contract change becomes). For example, if the delivery period of the combination (set) with index i is within the period of time that is X−1 months to X months later (X is a positive integer) from the time point (i.e., the present time) of performing the optimization process, the second determination unit 16 sets the weight wᵢ as follows.

wᵢ=1/X

In this instance, if the delivery period is less than one month from the time (the present time) of the optimization process, the second determination unit 16 sets “wᵢ=1”. If the delivery period is more than one month but less than two months, the second determination unit 16 sets “wᵢ=½”. Without being limited to the above expression, the second determination unit 16 may refer to any expression or a look-up table previously stored in the storage device 4 or the memory 12, and calculate the weight wᵢ based on the closeness between the delivery period of the combination and the present time.

In addition, in the event that a partial change of transaction conditions occurs when the initial plan based on the optimization process formulated by the first determination unit 15 is in progress, the second determination unit 16 may exclude, from the target of matching, one or more sets of the seller, the buyer, and the vessel whose delivery period of the goods is past or soon within a predetermined number of days and the change thereof is substantially impossible. In this case, for example, the second determination unit 16 determines a new combination by the optimization processing based on the coincidence degree g for the sets of the seller, the buyer, and the vessel whose delivery period can be changed. In another example, the second determination unit 16 may set, to an infinite value or a value equivalent thereto, the weight wᵢ for index i corresponding to the combination (set) of the seller, the buyer, and the vessel assigned at such a delivery time that is substantially non-modifiable.

Next, a description will be given of the method of determining the weight wᵢ based on the profit of the mediator with respect to each set. In this case, the second determination unit 16 determines the weight wᵢ based on the differential profit “p_{s, b}” when the goods is delivered from the seller s to the buyer b, which is used in the expression (1). For example, the second determination unit 16 determines the weight w as in the following expression, wherein the weight for the set of the sellers and the buyer b is denoted by “w_{s, b}”.

w_{s,b}=p_{s,b}

In this way, the second determination unit 16 increases the weight w for a set of the seller and the buyer with increasing profit of the mediator derived from the set. Thereby, the second determination unit 16 can determine the coincidence degree g suitably taking into consideration the profit of the mediator.

The second determination unit 16 may assign the weight win consideration of both of the delivery period and the profit. In this case, for example, the second determination unit 16 determines the weight w to be a weight obtained by multiplying the weight determined in consideration of the profit of the mediator by the weight determined in consideration of the delivery period. Instead of multiplying the weight determined in consideration of the profit of the mediator by the weight determined in consideration of the delivery period, the second determination unit 16 may determine the weight w from these weights with reference to a predetermined expression or look-up table.

The second determination unit 16 may calculate the coincidence degree g by considering the combination of only the sellers s and the buyers b without considering the vessels v. In this case, for example, the second determination unit 16 calculates the weighted coincidence degree g based on the following expression (6). However, “α_{s, b}=1” means to sell and deliver the goods from the seller s to buyer b regardless of the type of the vessel.

$$\begin{matrix}[ Formula 11 ] & \\ g ( α , β ) = {\sum }_{s = 1}^{S} {\sum }_{b = 1}^{B} {w}_{s , b} \cdot [ 1 {if}^{‶} {α}_{s , b} = {β}_{s , b} = {1}^{″} ] & ( 6 )\end{matrix}$$

Even in this case, the second determination unit 16 may formulate a change reflection plan so that the combination of the sellers and the buyers is as consistent as possible from the initial plan.

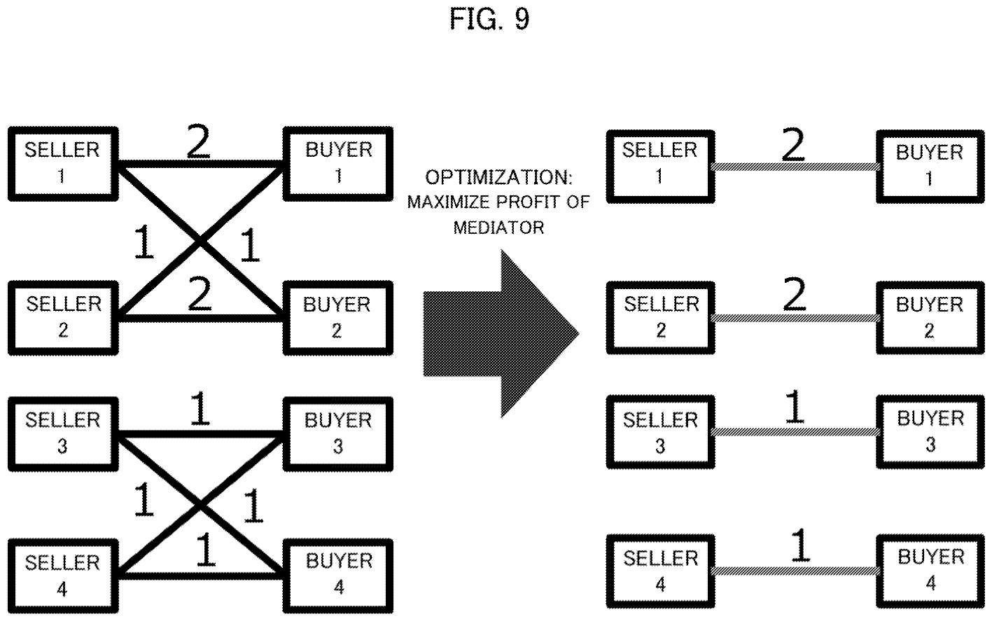

Next, the technical effects of the above-described optimization process will be specifically described with reference to FIGS. 9 to 12.

FIG. 9 shows a simplified specific example of the optimization process performed by the first determination unit 15. In FIG. 9, for simplicity of explanation, it is assumed that there are four sellers (seller 1 through seller 4) and four buyers (buyer 1 through buyer 4). In FIG. 9, a buyer and a seller that can be combined on the basis of the transaction conditions are connected by line, and the degree of profit (here, “1” or “2”) of the mediator derived from each combination (set) is specified. It is noted that the combination of vessels is not considered here for simplicity of explanation.

In this case, the first determination unit 15 determines the combination of the sellers and the buyers so as to maximize the profit of the mediator (see expression (2)). As a result, the first determination unit 15 generates a plan that combines “seller 1” and “buyer 1”, “seller 2” and “buyer 2”, “seller 3” and “buyer 3”, “seller 4” and “buyer 4”.

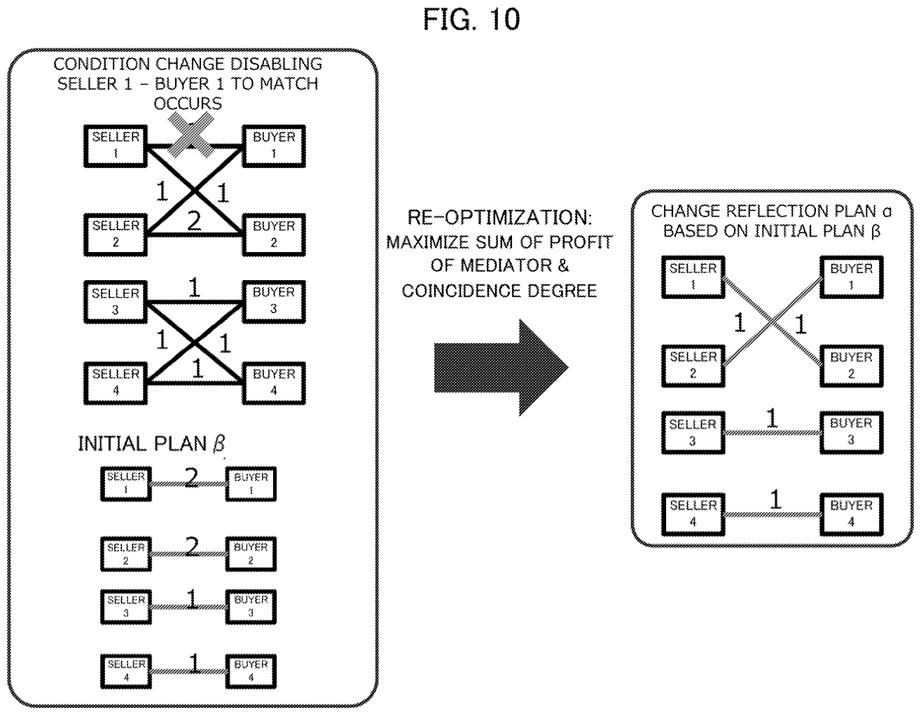

FIG. 10 shows a simplified specific example of the optimization process performed by the second determination unit 16 in the specific example shown in FIG. 9. In this case, after the optimization process by the first determination unit 15 shown in FIG. 9, a change in the transaction conditions occurs, which disables “seller 1” and “buyer 1” to be combined. In this case, the second determination unit 16 determines, according to the expression (3), the combination of the sellers and the buyers, which maximizes the objective function corresponding to the sum of the profit of the mediator and the coincidence degree g based on the transaction conditions after the change and the matching result β of the initial plan. As a result, the second determination unit 16 generates a change reflection plan that combines “seller 1” and “buyer 2”, “seller 2” and “buyer 1”, “seller 3” and “buyer 3”, “seller 4” and “buyer 4”. The change reflection plan is consistent with the initial plan in terms of the combinations (sets) of “seller 3” and “buyer 3”, “seller 4” and “buyer 4”, and the change from the initial plan is as small as possible, while taking the profit of the mediator into consideration.

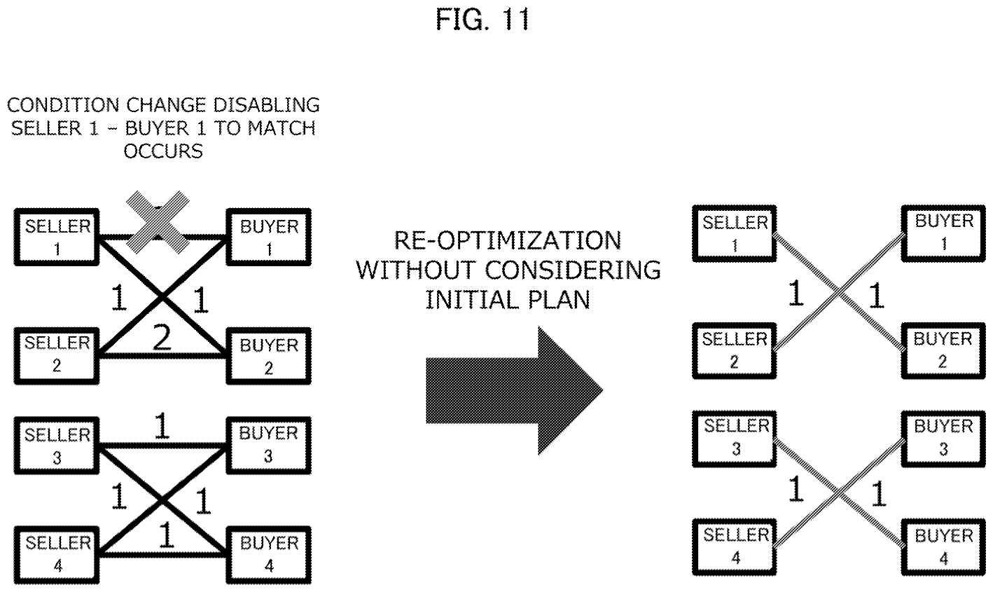

FIG. 11 shows the combination of the sellers and buyers when the optimization process is executed without considering the initial plan when the change in the transaction conditions occurs. In FIG. 11, when the same change in the transaction conditions as in FIG. 10 occurs, the combination of the sellers and the buyers is determined such that the profit of the mediator (see expression (2)) is maximized without considering the coincidence degree g based on the initial plan. As a result, a change reflection plan combining “seller 1” and “buyer 2”, “seller 2” and “buyer 1”, “seller 3” and “buyer 4”, “seller 4” and “buyer 3” is generated. This change reflection plan is different from the initial plan in all combination, although the same profit of the mediator as the change reflection plan shown in FIG. 10 is produced, and there has been a drastic change from the initial plan. Since the negotiation with the contractors becomes enormous in order to execute this plan, the influence by the plan change is large, and therefore it does not become a favorable matching result for the mediator.

In view of the above, the second determination unit 16 determines the combination of the sellers and the buyers such that the change from the initial plan is as small as possible by performing the maximization of the objective function in consideration of the coincidence degree g. Thus, the information processing device 1 can formulate a change reflection plan similar to the initial plan while reflecting (i.e., changing the constraints of the optimization problem) the delay situation and the unsuccessful information. Then, the information processing device 1 can suitably present a matching result preferable for the mediator.

(4-4) Display Example

Next, a description will be given of a matching screen image displayed by the display device 3 based on the display information S2 supplied from the display control unit 17 of the information processing device. Hereinafter, the matching detail screen image which is a matching screen image showing details of the plan selected by the user and the matching instruction screen image which is a matching screen image which accepts the designation of the execution condition of the optimization process will be described in order.

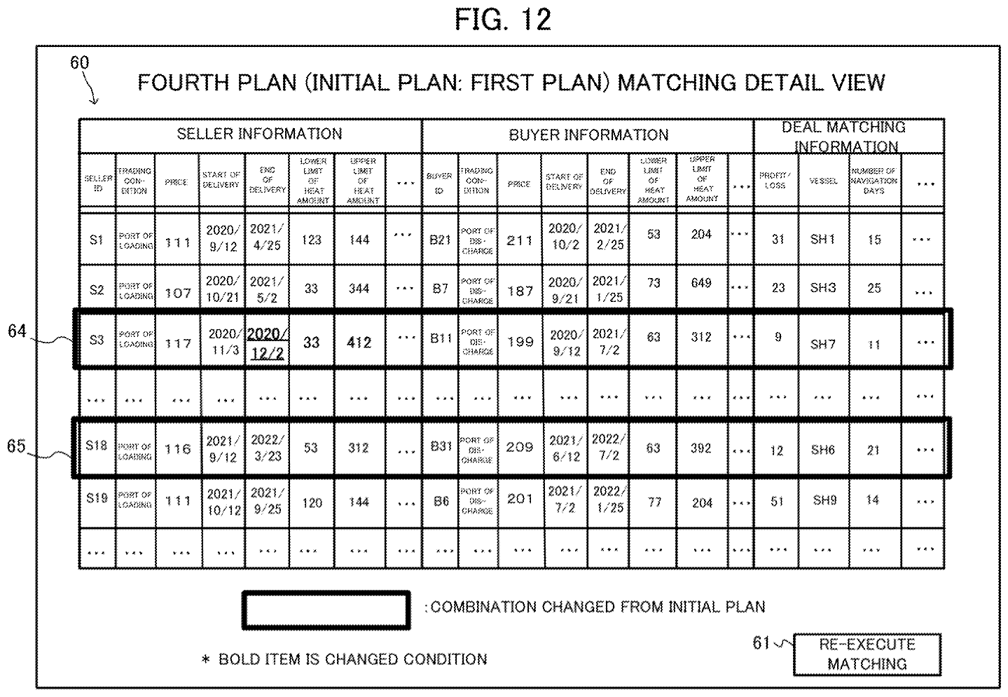

FIG. 12 is a display example of a matching detail screen image displayed by the display device 3 under the control of the display control unit 17 of the information processing device 1. The display control unit 17 displays a matching table 60 and a matching re-execution button 61 on the matching detail screen image shown in FIG. 12. Here, the display control unit 17 sets the first plan as the initial plan, and displays the details of the fourth plan in which the transaction conditions are changed from the first plan on the display device 3. Here, as an example, the transaction target is assumed to be LNG.

The matching table 60 mainly has each major item of “seller information”, “buyer information”, “deal matching information”. The major item “seller information” includes sub-items of “seller ID”, “trading condition”, “price”, “start of delivery”, “end of delivery”, “lower limit of heat amount”, and “upper limit of heat amount”. The major item “buyer information” includes sub-items of “buyer ID”, “trading condition”, “price”, “start of delivery”, “end of delivery”, “lower limit of heat amount”, and “upper limit of heat amount”. The major item “deal matching information” includes sub-items of “profit/loss”, “vessel” and “number of navigation days”.

Here, the display control unit 17 generates each record of the matching table 60, for each combination (pair) of the seller and the buyer determined by the first determination unit 15, based on the corresponding seller information 41 and buyer information 42. For example, the display control unit 17 displays the seller ID indicated by the seller identification information included in the corresponding seller information 41 in the item “seller ID”. Further, the display control unit 17 displays, in the item “trading condition”, the information (herein, information indicating whether the delivery location is the port of loading or the port of discharge) indicative of the delivery location indicated by the delivery location information included in the seller information 41, and displays, in the item “price”, the price indicated by the price information included in the seller information 41. Further, the display control unit 17 displays, in the items “start of delivery” and “end of delivery”, the start and end of the delivery period indicated by the delivery period information included in the seller information 41, respectively. Further, the display control unit 17 displays, in the items “lower limit of heat amount” and “upper limit of heat amount”, the lower limit and the upper limit of the trading volume indicated by the trading volume information included in the seller information 41, respectively. The display control unit 17 displays the buyer ID indicated by the buyer identification information included in the corresponding buyer information 42 in the item “buyer ID”. Further, the display control unit 17 displays, in the item “trading condition”, the information (herein, information indicating whether the delivery location is the port of loading or the port of discharge) indicative of the delivery location indicated by the delivery location information included in the buyer information 42, and displays, in the item “price”, the price indicated by the price information included in the buyer information 42. Further, the display control unit 17 displays, in the items “start of delivery” and “end of delivery”, the start and end of the delivery period indicated by the delivery period information included in the buyer information 42, respectively. Further, the display control unit 17 displays, in the items “lower limit of heat amount” and “upper limit of heat amount”, the lower limit and the upper limit of the trading volume indicated by the trading volume information included in the buyer information 42, respectively.

Further, in addition to the information regarding the combination of the sellers and the buyers, the display control unit 17 displays, in the item “deal matching information” with respect to each record in the matching table 60, the profit/loss and allocated vessels for the corresponding transactions. Specifically, the display control unit 17 displays, in the item of “profit/loss”, the profit or loss calculated by the second determination unit 16 for each transaction (i.e., a combination of the seller and the buyer). Further, on the basis of the vessel name information included in the vessel information 43, the display control unit 17 displays, in the item “vessel”, the identification information of the vessel allocated for each transaction by the second determination unit 16. Further, the display control unit 17 displays, in the item “number of navigation days”, the number of navigation days that the second candidate determination unit 16 has determined for each transaction. Further, the display control unit 17 may further include, in the item “deal matching information”, the item indicating the trading volume (heat amount) when the profit of the user of the information processing device 1 is maximized, the item indicating the delivery timing regarding the seller and the delivery timing regarding the buyer when the profit of the user is maximized, respectively. Such information is generated in the optimization process by the second determination unit 16 and is supplied to the display control unit 17.

In addition, the display control unit 17 highlights a record, which indicates a different combination of a seller, a buyer, and a vessel to be used from the first plan that is the initial plan, by bold frames 64 and 65. Thus, the display control unit 17 can allow the viewer to suitably grasp the changed portion from the first plan that is the initial plan. Further, the display control unit 17 highlights the changed portion of the transaction conditions from the first plan, which is the initial plan, in bold. Here, the values in “end of delivery,” “lower limit of heat amount” and “upper limit of heat amount” regarding the seller ID “S3” fall under the changed portion from the first plan.

In addition, in some embodiments, in the matching detail screen image, cells displaying various transaction conditions are selectable, and the display control unit 17 receives input of information on the changed transaction condition regarding the selected cell. When it is detected that the matching re-execution button 61 is selected after the change of contents in any cell in the matching table 60, the display control unit 17 supplies information indicating the content of the changed cell to the second determination unit 16. Then, the second determination unit 16 executes the optimization process while changing the transaction conditions based on the information received from the display control unit 17.

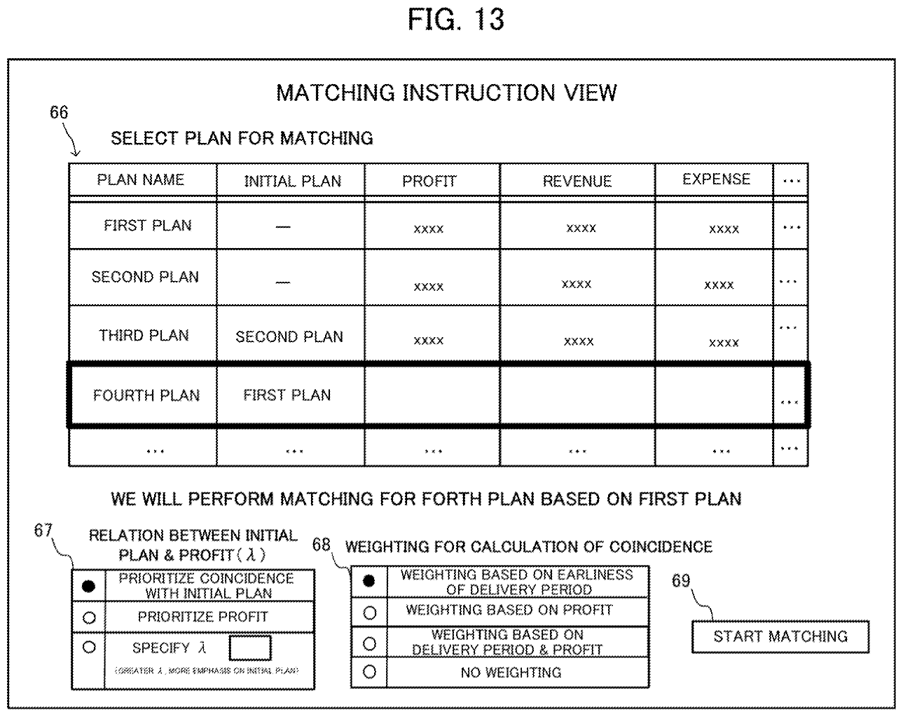

FIG. 13 is a display example of a matching instruction screen image displayed by the display device 3 under the control of the display control unit 17 of the information processing device 1. The display control unit 17 displays a plan list table 66, a first input field 67, a second input field 68, and a matching calculation instruction button 69 on the matching instruction screen image shown in FIG. 13.

The plan list table 66 is a table showing outlines of plans stored as the plan information 45 and plans in which the transaction conditions are changed from the plans. The plan list table 66 includes items “plan name”, “initial plan”, “profit”, “revenue”, and “expense”. Here, the “third plan” corresponds to a change reflection plan whose initial plan is the second plan. On the other hand, in the “fourth plan”, the transaction conditions have been changed from the first plan that is the initial plan, and the items “profit”, “revenue”, and “expense” are blank because the optimization process is not executed yet.

Here, the display control unit 17 recognizes the fourth plan as a matching target because the record of the “fourth plan” is selected in the plan list table 66. Then, since the first plan is designated as the initial plan of the fourth plan, the display control unit 17 determines that the optimization process by the second determination unit 16 is required. Thus, the display control unit 17 accepts, in the first input field 67 and the second input field 68, the designation of the parameters necessary for the optimization process by the second determination unit 16.

The first input field 67 is an input field for receiving the designation of the weight parameter λ for the coincidence degree g, and herein is a selection field in a radio button format as an example. The first input field 67 provides three options “prioritize coincidence with initial plan”, “prioritize profit”, and “specify λ”. Here, when the option “prioritize coincidence with initial plan” is selected, the second determination unit 16 sets the parameter 2, in the objective function, such that the influence from the coincidence degree g becomes larger than the influence from the function f representing the gross profit of the mediator. The value of the parameter λ in this case, for example, is previously stored in the storage device 4 or memory 12 or the like. In addition, when the option “prioritize profit” is selected, the second determination unit 16 sets the parameter λ in the objective function such that the influence from the coincidence degree g becomes smaller than the influence from the function f representing the gross profit of the mediator. The value of the parameter λ in this case is a value smaller than the value of the parameter λ to be set in the case of “prioritize coincidence with initial plan” and is, for example, stored in the storage device 4 or the memory 12 in advance. Further, when the option “specify 2” is selected, the second determination unit 16 sets the numerical value inputted to an input field provided in the first input field 67 as the parameter 2.

The second input field 68 is an input field for receiving a designation relating to the weight regarding the weighted coincidence degree g, and herein is a selection field in a radio button format as an example. The second input field 68 has options “weighting based on earliness of delivery period”, “weighting based on profit”, “weighting based on delivery period & profit”, and “no weighting”. Here, when the option “weighting based on earliness of delivery period” is selected, the second determination unit 16 sets the weight w according to the “method of determining the weight wᵢ based on the delivery period of the goods to be traded” described in the section “(4-3) Optimization by Second Determination Unit”. When the option “weighting based on profit” is selected, the second determination unit 16 sets, as the weight w, the weight derived from both of the weight based on the delivery period and the weight based on the profit. Further, when the option “no weighting” is selected, the second determination unit 16 determines the coincidence degree g without using the weight w (i.e., based on the expression (4)).

When it is detected that the matching calculation instruction button 69 is selected, the display control unit 17 supplies the input contents on the matching instruction screen image to the second determination unit 16, and the second determination unit 16 executes the optimization process for the designated plan (in this case, the fourth plan) on the basis of the input contents. Thereafter, the display control unit 17 receives the result of the optimization process by the second determination unit 16, and displays numerical values based on the result of the optimization process in items “profit”, “revenue” and “expense”.

Thus, according to the matching instruction screen image illustrated in FIG. 13, the display control unit 17 can suitably receive the user input of information necessary for the optimization process to be executed by the second determination unit 16.

(4-5) Process Flow

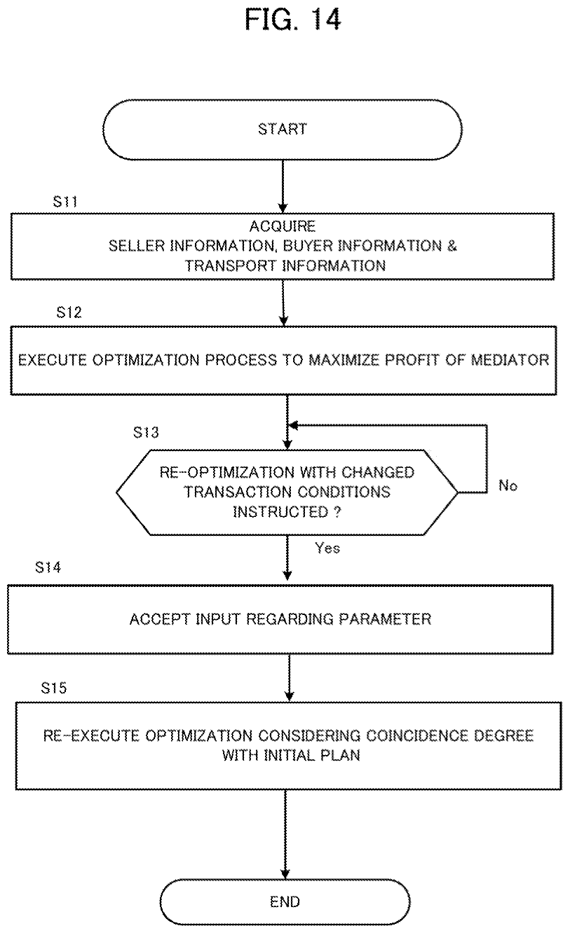

FIG. 14 is an example of a flowchart illustrating a processing procedure that is executed by the information processing device 1 according to the first example embodiment. Here, FIG. 14 shows a process flow of generating a change reflection plan in which the plan formulated by the optimization process is set as the initial plan after the information processing device 1 performs the optimization process under certain transaction conditions.

First, the first determination unit 15 of the information processing device 1 acquires seller information 41, buyer information 42, and transport information such as vessel information 43 and port information 44 from the storage device 4 through the interface 13 (step S11). Thus, the first determination unit 15 recognizes the transaction conditions that are premises in the optimization process.

Then, the first determination unit 15 executes an optimization process to maximize the profit of the mediator based on various information acquired at step S11 (step S12). In this instance, the first determination unit 15 sets constraints based on the information acquired at step S11 and determines the combination of the sellers and the buyers and the transport schedule so as to maximize the profit of the mediator (see the expression (2)).

Next, the information processing device 1 determines whether or not the re-optimization with changed transaction conditions has been instructed (step S13). In this case, for example, the display control unit 17 determines whether or not a user input instructing re-optimization in which the transaction conditions are changed from the initial plan is detected on the matching screen image shown in FIG. 12 or FIG. 13. If the re-optimization with changed transaction conditions has not been instructed (step S13; No), the information processing device 1 continues to perform the determination process at step S13.

If the re-optimization with changed transaction conditions has been instructed (step S13; Yes), the display control unit 17 accepts an input relating to a parameter required for the optimization process by the second determination unit 16 (step S14). In this case, for example, the display control unit 17 receives the input relating to at least one of the parameter λ or the weight w on the matching screen image.

Then, the second determination unit 16 re-executes the optimization process considering the coincidence degree g with the initial plan (step S15). In this instance, the second determination unit 16 uses the parameter(s) specified at step S14 to determine the combination of the sellers and the buyers and the transport schedule so as to maximize the objective function positively correlated with the coincidence degree g and the profit of the mediator (see, e.g., the equation (3)). Thus, the information processing device 1 can formulate a change reflection plan similar to the initial plan while reflecting the delay situation and the unsuccessful information.

(5) Modifications

Next, a description will be given of preferred modifications to the first example embodiment. The following modifications may be applied to the first example embodiment in any combination.

(First Modification)

The information processing device 1 determined the transportation schedule on the assumption that a vessel is used as a transportation (transport means). Alternatively, the information processing device 1 may determine the transport schedule of the transaction target by means of transportation other than vessels (such as airplanes) or a combination of vessels with the other transportation. In this case, the storage device 4 stores, in addition to or in place of the vessel information 43 and port information 44, information on other transportations that can be used, information on ports (airports) used by other transportations, and the like.

(Second Modification)

The information processing device 1 may not execute the determination process of the transport schedule based on the vessel information 43 and the port information 44. In this case, the first determination unit 15 and the second determination unit 16 respectively determine the combination of the sellers and the buyers in the optimization process based on the seller information 41 and the buyer information 42 without referring to the vessel information 43 and the port information 44.

### Second Example Embodiment

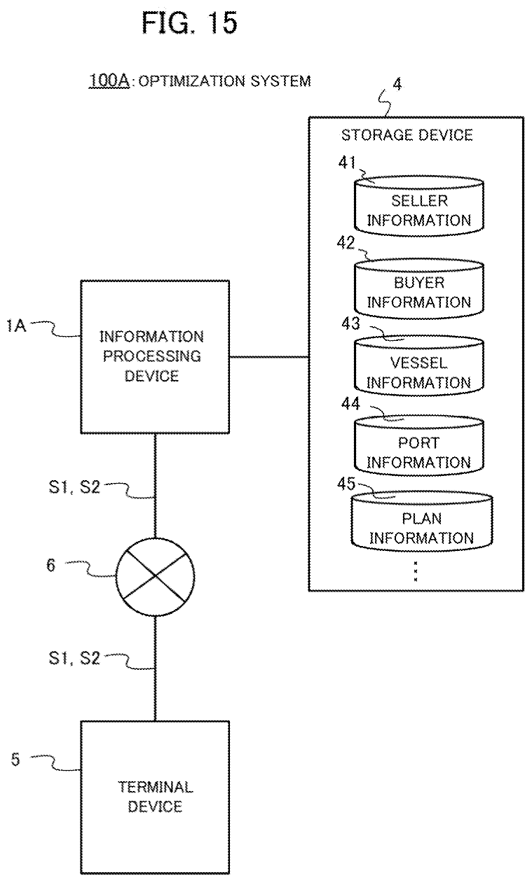

FIG. 15 shows a configuration of an optimization system 100A in the second example embodiment. As shown in FIG. 15, the optimization system 100A mainly includes an information processing device 1A, a storage device 4, and a terminal device 5. The information processing device 1A and the terminal device 5 perform data communication via the network 6 with each other.

The information processing device 1A has the same configuration as the information processing device 1 according to the first example embodiment and executes the same optimization process as the optimization process executed by the information processing device 1. In this case, the information processing device 1A receives the input information S1 from the terminal device 5 via the network 6 while the information processing device 1 in the first example embodiment receives the input information S1 from the input device 2. Further, the information processing device 1A transmits the display information S2 to the terminal device 5 via the network 6 while the information processing device 1 in the first example embodiment transmits the display information S2 to the display device 3. Accordingly, the information processing device 1A according to the second example embodiment functions as a server device.

The terminal device 5 is a terminal equipped with an input function, a display function, and a communication function, and functions as the input device 2 and the display device 3 in the first example embodiment. Examples of the terminal device 5 include a personal computer, a tablet-type terminal, and a PDA (Personal Digital Assistant). The terminal device 5 transmits the input information S1 generated based on the received user input to the information processing device 1A through the network 6. When receiving the display information S2 from the information processing device 1A, the terminal device 5 displays the matching summary view and the matching detail view based on the display information S2.

The information processing device 1A according to the second example embodiment can suitably present the contents to be displayed on the display device 3 in the first example embodiment to the user of the terminal device 5. Therefore, when the user of the terminal device 5 is a mediator, even when there is a change in the transaction conditions after the formulation of the plan, it is possible to suitably present a matching result such that the change from the initial plan is as little as possible.

### Third Example Embodiment

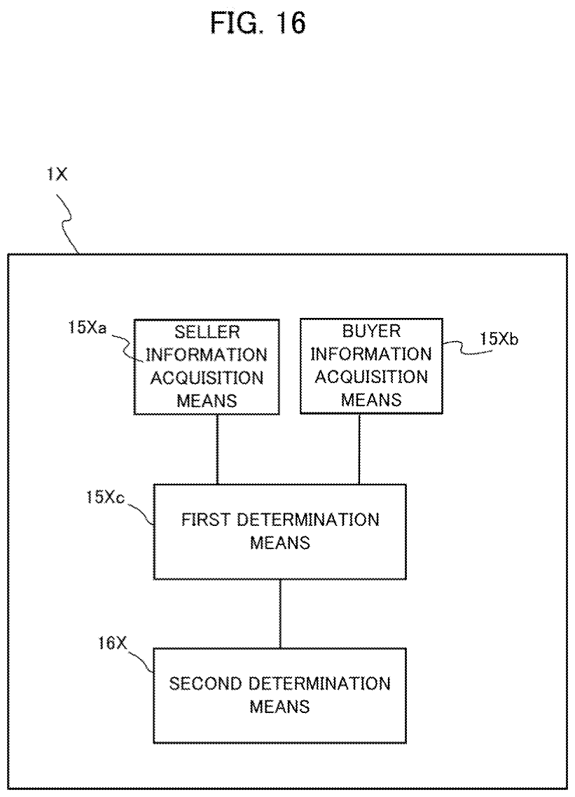

FIG. 16 is a functional block diagram of an information processing device 1X according to a third example embodiment. The information processing device 1X mainly includes a seller information acquisition means 15Xa, a buyer information acquisition means 15Xb, a first determination means 15Xc, and a second determination means 16X.

The seller information acquisition means 15Xa is configured to acquire seller information which indicates sell conditions specified by each of sellers of a transaction target. The buyer information acquisition means 15Xb is configured to acquire buyer information which indicates buy conditions specified by each of buyers of the transaction target. The first determination means 15Xc is configured to determine a first combination of each of the sellers and each of the buyers establishing transactions of the transaction target, based on the seller information, the buyer information, and a profit of a mediator which mediates the transactions. The first combination may include not only the sellers and buyers but also transportations such as vessels to be used. Examples of the seller information acquisition means 15Xa, the buyer information acquisition means 15Xb, and the first determination means Xc include the first determination unit 15 in the first example embodiment and in the second example embodiment.

The second determination means 16X is configured, when a change in conditions of the transaction occurs, to determine a second combination of each of the sellers and each of the buyers establishing the transactions, based on the buyer information and the seller information in which the change is reflected, the profit of the mediator, and the first combination. The second combination may include not only the sellers and buyers but also transportations such as vessels to be used. Examples of the second determination means 16X include the second determination unit 16 in the first example embodiment and the second example embodiment.

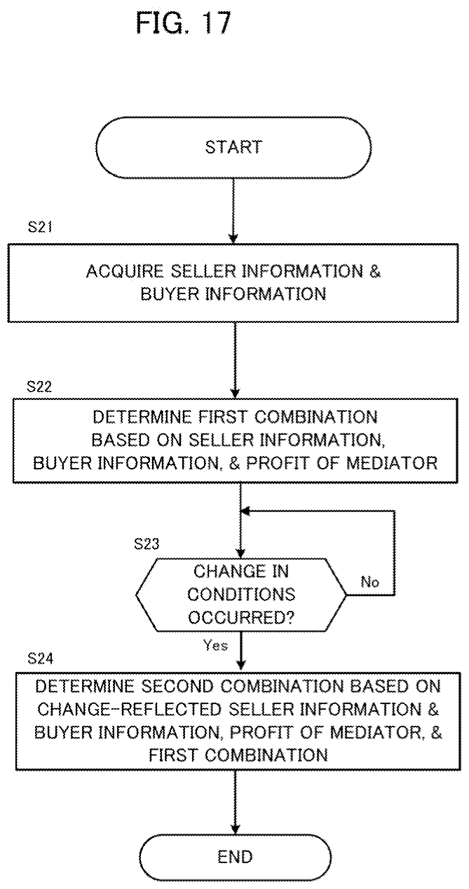

FIG. 17 is an example of a flowchart that is executed by the information processing device 1X in the third example embodiment. First, the seller information acquisition means 15Xa acquires seller information which indicates sell conditions specified by each of sellers of a transaction target and the buyer information acquisition means 15Xb acquires buyer information which indicates buy conditions specified by each of buyers of the transaction target (step S21). Next, the first determination means 15Xc determines a first combination of each of the sellers and each of the buyers establishing transactions of the transaction target, based on the seller information, the buyer information, and a profit of a mediator which mediates the transactions (step S22). If a change in conditions of the transaction occurs (step S23; Yes), the second determination means 16X determines a second combination of each of the sellers and each of the buyers establishing the transactions, based on the buyer information and the seller information in which the change is reflected, the profit of the mediator, and the first combination (step S24). If a change in conditions of the transaction does not occur (step S23; No), the second determination means 16X does not execute the process at step S24. In this case, instead of continuing to make the determination at step S23, the information processing device 1X may terminate the process of the flowchart.

Even when there is a change in the transaction conditions after the determination of the combination of the sellers and the buyers, the information processing device 1X according to the third example embodiment can suitably determine the second combination satisfying the changed transaction conditions in consideration of the first combination that is the original combination.

In the example embodiments described above, the program is stored by any type of a non-transitory computer-readable medium (non-transitory computer readable medium) and can be supplied to a processor or the like that is a computer. The non-transitory computer-readable medium include any type of a tangible storage medium. Examples of the non-transitory computer readable medium include a magnetic storage medium (e.g., a flexible disk, a magnetic tape, a hard disk drive), a magnetic-optical storage medium (e.g., a magnetic optical disk), CD-ROM (Read Only Memory), CD-R, CD-R/W, a solid-state memory (e.g., a mask ROM, a PROM (Programmable ROM), an EPROM (Erasable PROM), a flash ROM, a RAM (Random Access Memory)). The program may also be provided to the computer by any type of a transitory computer readable medium. Examples of the transitory computer readable medium include an electrical signal, an optical signal, and an electromagnetic wave. The transitory computer readable medium can provide the program to the computer through a wired channel such as wires and optical fibers or a wireless channel.

The whole or a part of the example embodiments described above can be described as, but not limited to, the following Supplementary Notes.

### [Supplementary Note 1]

An information processing device comprising:

a seller information acquisition means configured to acquire seller information which indicates sell conditions specified by each of sellers of a transaction target;

a buyer information acquisition means configured to acquire buyer information which indicates buy conditions specified by each of buyers of the transaction target;

a first determination means configured to determine a first combination of each of the sellers and each of the buyers establishing transactions of the transaction target, based on the seller information, the buyer information, and a profit of a mediator which mediates the transactions; and

a second determination means configured, when a change in conditions of the transaction occurs, to determine a second combination of each of the sellers and each of the buyers establishing the transactions, based on the buyer information and the seller information in which the change is reflected, the profit of the mediator, and the first combination.

### [Supplementary Note 2]

The information processing device according to Supplementary Note 1,

wherein the second determination means is configured to determine the second combination based on a degree of coincidence with the first combination.

### [Supplementary Note 3]

The information processing device according to Supplementary Note 2,

wherein the second determination means is configured to determine the degree of coincidence based on the number of seller-buyer sets in common with the first combination.

### [Supplementary Note 4]

The information processing device according to Supplementary Note 2 or 3,

wherein the second determination means is configured to calculate the degree of coincidence based on a weight determined for each of the seller-buyer sets in common with the first combination.

### [Supplementary Note 5]

The information processing device according to Supplementary Note 4,

wherein the second determination means is configured to determine the weight for each of the seller-buyer sets based on the profit of the mediator derived from the transactions of each of the seller-buyer sets.

### [Supplementary Note 6]

The information processing device according to Supplementary Note 4,

wherein the second determination means is configured to determine the weight for each of the seller-buyer sets, based on a delivery time of the transaction target of each of the seller-buyer sets.

### [Supplementary Note 7]

The information processing device according to any one of Supplementary Notes 2 to 6,

wherein the second determination means is configured to determine, as the second combination, a combination of each of the sellers and each of the buyers which establishes the transactions and which maximizes an objective function positively correlated with the degree of coincidence.

### [Supplementary Note 8]

The information processing device according to Supplementary Note 7,

wherein the second determination means is configured to determine the objective function to be a sum of

a value obtained by multiplying the degree of coincidence by a parameter and

the profit of the mediator.

### [Supplementary Note 9]

The information processing device according to Supplementary Note 8,

wherein the second determination means is configured to determine the parameter based on an input specifying information on the parameter.

### [Supplementary Note 10]

The information processing device according to any one of Supplementary Notes 1 to 9, further comprising

a display control means configured to display the second combination while highlighting a seller-buyer set different from the first combination.

### [Supplementary Note 11]

The information processing device according to any one of Supplementary Notes 1 to 9, further comprising

a display control means configured to display, in an instruction screen image instructing determination of the second combination by the second determination means, an input field for accepting an input for specifying information on a parameter to be used by the second determination means.

### [Supplementary Note 12]

The information processing device according to any one of Supplementary Notes 1 to 11, further comprising

a transport information acquisition means configured to acquire transport information regarding transport of the transaction target from the sellers to the buyers,

wherein the first determination means is configured to determine the first combination and a first schedule of the transport corresponding to the first combination, based on the seller information, the buyer information, the profit of the mediator, and the transport information, and

wherein the second determination means is configured to determine the second combination and a second schedule of the transport corresponding to the second combination, based on: the seller information, the buyer information, and the transport information in which the change is reflected; the profit of the mediator; the first combination; and the first schedule.

### [Supplementary Note 13]

The information processing device according to Supplementary Note 12,

wherein the first determination means is configured to determine, as the first schedule, transportations to be used for the transport of the transaction target between the sellers and the buyers combined by the first combination, and

wherein the second determination means is configured to determine, as the second schedule, transportations to be used for the transport of the transaction target between the sellers and the buyers combined by the second combination.

### [Supplementary Note 14]

A control method executed by a computer, the control method comprising:

acquiring seller information which indicates sell conditions specified by each of sellers of a transaction target;

acquiring buyer information which indicates buy conditions specified by each of buyers of the transaction target;

determining a first combination of each of the sellers and each of the buyers establishing transactions of the transaction target, based on the seller information, the buyer information, and a profit of a mediator which mediates the transactions; and

when a change in conditions of the transaction occurs, determining a second combination of each of the sellers and each of the buyers establishing the transactions, based on the buyer information and the seller information in which the change is reflected, the profit of the mediator, and the first combination.

### [Supplementary Note 15]

A storage medium storing a program executed by a computer, the program causing the computer to:

acquire seller information which indicates sell conditions specified by each of sellers of a transaction target;

acquire buyer information which indicates buy conditions specified by each of buyers of the transaction target;

determine a first combination of each of the sellers and each of the buyers establishing transactions of the transaction target, based on the seller information, the buyer information, and a profit of a mediator which mediates the transactions; and

when a change in conditions of the transaction occurs, determine a second combination of each of the sellers and each of the buyers establishing the transactions, based on the buyer information and the seller information in which the change is reflected, the profit of the mediator, and the first combination.

While the invention has been particularly shown and described with reference to example embodiments thereof, the invention is not limited to these example embodiments. It will be understood by those of ordinary skilled in the art that various changes in form and details may be made therein without departing from the spirit and scope of the present invention as defined by the claims. In other words, it is needless to say that the present invention includes various modifications that could be made by a person skilled in the art according to the entire disclosure including the scope of the claims, and the technical philosophy. All Patent and Non-Patent Literatures mentioned in this specification are incorporated by reference in its entirety.

### DESCRIPTION OF REFERENCE NUMERALS

1, 1A, 1X Information processing device
2 Input device
3 Display device
4 Storage device
5 Terminal device
100, 100A Optimization system

What is claimed is:

1. An information processing device comprising:
at least one memory configured to store instructions; and
at least one processor configured to execute the instructions to:
acquire seller information which indicates sell conditions specified by each of sellers of a transaction target;
acquire buyer information which indicates buy conditions specified by each of buyers of the transaction target;
determine a first combination of each of the sellers and each of the buyers establishing transactions of the transaction target, based on the seller information, the buyer information, and a profit of a mediator which mediates the transactions; and
when a change in conditions of the transaction occurs, determine a second combination of each of the sellers and each of the buyers establishing the transactions, based on the buyer information and the seller information in which the change is reflected, the profit of the mediator, and the first combination.

2. The information processing device according to claim 1,
wherein the at least one processor is configured to execute the instructions to determine the second combination based on a degree of coincidence with the first combination.

3. The information processing device according to claim 2,
wherein the at least one processor is configured to execute the instructions to determine the degree of coincidence based on the number of seller-buyer sets in common with the first combination.

4. The information processing device according to claim 2,
wherein the at least one processor is configured to execute the instructions to calculate the degree of coincidence based on a weight determined for each of the seller-buyer sets in common with the first combination.

5. The information processing device according to claim 4,
wherein the at least one processor is configured to execute the instructions to determine the weight for each of the seller-buyer sets based on the profit of the mediator derived from the transactions of each of the seller-buyer sets.

6. The information processing device according to claim 4,
wherein the at least one processor is configured to execute the instructions to determine the weight for each of the seller-buyer sets, based on a delivery time of the transaction target of each of the seller-buyer sets.

7. The information processing device according to claim 2,
wherein the at least one processor is configured to execute the instructions to determine, as the second combination, a combination of each of the sellers and each of the buyers which establishes the transactions and which maximizes an objective function positively correlated with the degree of coincidence.

8. The information processing device according to claim 7,
wherein the at least one processor is configured to execute the instructions to determine the objective function to be a sum of a value obtained by multiplying the degree of coincidence by a parameter; and the profit of the mediator.

9. The information processing device according to claim 8,
wherein the at least one processor is configured to execute the instructions to determine the parameter based on an input specifying information on the parameter.

10. The information processing device according to claim 1,
wherein the at least one processor is configured to further execute the instructions to display the second combination while highlighting a seller-buyer set different from the first combination.

11. The information processing device according to claim 1,
wherein the at least one processor is configured to further execute the instructions to display, in an instruction screen image instructing determination of the second combination, an input field for accepting an input for specifying information on a parameter to be used.

12. The information processing device according to claim 1,
wherein the at least one processor is configured to further execute the instructions to acquire transport information regarding transport of the transaction target from the sellers to the buyers,
wherein the at least one processor is configured to execute the instructions to determine the first combination and a first schedule of the transport corresponding to the first combination, based on the seller information, the buyer information, the profit of the mediator, and the transport information, and
wherein the at least one processor is configured to execute the instructions to determine the second combination and a second schedule of the transport corresponding to the second combination, based on: the seller information, the buyer information, and the transport information in which the change is reflected; the profit of the mediator; the first combination; and the first schedule.

13. The information processing device according to claim 12,
wherein the at least one processor is configured to execute the instructions to determine, as the first schedule, transportations to be used for the transport of the transaction target between the sellers and the buyers combined by the first combination, and
wherein the at least one processor is configured to execute the instructions to determine, as the second schedule, transportations to be used for the transport of the transaction target between the sellers and the buyers combined by the second combination.

14. A control method executed by a computer, the control method comprising:
acquiring seller information which indicates sell conditions specified by each of sellers of a transaction target;
acquiring buyer information which indicates buy conditions specified by each of buyers of the transaction target;
determining a first combination of each of the sellers and each of the buyers establishing transactions of the transaction target, based on the seller information, the buyer information, and a profit of a mediator which mediates the transactions; and
when a change in conditions of the transaction occurs, determining a second combination of each of the sellers and each of the buyers establishing the transactions, based on the buyer information and the seller information in which the change is reflected, the profit of the mediator, and the first combination.

15. A non-transitory computer readable storage medium storing a program executed by a computer, the program causing the computer to:
acquire seller information which indicates sell conditions specified by each of sellers of a transaction target;
acquire buyer information which indicates buy conditions specified by each of buyers of the transaction target;
determine a first combination of each of the sellers and each of the buyers establishing transactions of the transaction target, based on the seller information, the buyer information, and a profit of a mediator which mediates the transactions; and
when a change in conditions of the transaction occurs, determine a second combination of each of the sellers and each of the buyers establishing the transactions, based on the buyer information and the seller information in which the change is reflected, the profit of the mediator, and the first combination.
